(19) United States
(12) Patent Application Publication
(10) Pub. No.: US 2009/0126590 A1
(43) Pub. Date: May 21, 2009

(54) Method and Device for Producing a Permanent as Well as Erasable Image on a Printing Plate

(75) Inventors: Peer Dilling, Friedberg (DE); Josef Goettling, Friedberg (DE); Thomas Hartmann, Mering (DE)

Correspondence Address: CROWELL & MORING LLP;INTELLECTUAL PROPERTY GROUP, P.O. BOX 14300, WASHINGTON, DC, 20044-4300, US

(73) Assignee: MAN Roland Druckmaschinen AG, Augsburg (DE)

(21) Appl. No.: 12/126,668

(22) Filed: May 23, 2008

(30) Foreign Application Priority Data
May 25, 2007 (DE) 10 2007 024 611.2

(51) Int. Cl. B41N 1/00

(52) U.S. Cl. 101/478

(57) ABSTRACT

A method and device for producing a permanent as well as erasable image on a printing plate, in particular within a printing press, is disclosed. A printing plate with a rewritable and erasable surface is made available. The surface of the printing plate made available is erased and a permanent and erasable image is created on the erased surface. Following the erasing of the surface, the surface is imaged, gummed and fixed, namely in such a way that, on the one hand, the imaging and the gumming and the fixing occur relative to the erasing in a chronologically sequential and spatially sequential manner, and that, on the other hand, the imaging and the gumming and the fixing each occur relative to one another in a chronologically parallel but spatially sequential manner.

This application claims the priority of German Patent Document No. 10 2007 024 611.2, filed May 25, 2007, the disclosure of which is expressly incorporated by reference herein.

### BACKGROUND AND SUMMARY OF THE INVENTION

The invention relates to a method as well as a device for producing a permanent as well as erasable image on a printing plate.

When printing with a printing plate, a differentiation is always made between methods that operate, on the one hand, with printing plates that can be written on once or, on the other hand, with rewritable printing plates. Printing methods that use rewritable printing plates are also referred to using the catch phrase “computer to press” or “direct imaging.” The present invention relates to a method for producing a permanent as well as erasable image on this type of rewritable as well as erasable printing plate. The applicant markets digital printing presses under the product designation of “DICOweb,” which operates with rewritable as well as erasable printing plates. With respect to the principles of DICOweb technology, reference is made to “Handbook of Print Media” [Handbuch der Printmedien], by Helmut Kipphan, pages 674-680, published in 2000 by Springer-Verlag [Springer Publishers].

When producing a permanent as well as erasable image on this type of rewritable as well as erasable DICOweb printing plate, a printing plate positioned on a plate cylinder preferably undergoes an erasing step as well as an imaging step. Following the imaging, the printing plate is fixed and conditioned, whereby the conditioning can take place before or even after the fixing. The conditioning of the printing plate serves, among other things, to more strongly differentiate printing and non-printing areas of the printing plate as well as to make the non-printing areas of the printing plate hydrophilic.

In addition, providing the surfaces of printing plates with a gummed coating in order to protect them from contamination or oxidation from atmospheric oxygen is already customary in printing technology. If gumming a printing plate takes place after the imaging step, it is also possible to dispense with conditioning.

According to DICOweb technology known from practice, all process steps, i.e., the erasing, imaging, fixing and conditioning, can be performed as separate process steps chronologically one after the other and therefore in a chronologically sequential manner. This results in a process that has a relatively long duration.

To shorten the process duration for producing a permanent as well as erasable image on a rewritable as well as erasable printing plate, German Patent Document No. DE 100 32 703 A1 proposes that all process steps be performed simultaneously. Thus, according to DE 100 32 703 A1, the erasing, imaging as well as the fixing or curing take place at the same time.

Starting herefrom, the present invention is based on the objective of creating a novel method for producing a permanent as well as erasable image on a printing plate.

According to the method of the invention, following the erasing of the surface, the surface is imaged, gummed and fixed, namely in such a way that, on the one hand, the imaging and the gumming and the fixing occur relative to the erasing in a chronologically sequential and spatially sequential manner, and that, on the other hand, the imaging and the gumming and the fixing each occur relative to one another in a chronologically parallel but spatially sequential manner.

Within the scope of the inventive method, the erasing takes place chronologically before the imaging, gumming and fixing. The erasing of the surface is a process step that is conducted in a chronologically sequential and spatially sequential manner relative to imaging, gumming and fixing. The imaging, gumming and fixing occur in a chronologically parallel but spatially sequential manner. The present invention is based on the knowledge that even though the imaging, gumming and fixing can be performed simultaneously, the process step of erasing does not lend itself to being performed simultaneously, however. Thus, in contrast to imaging, gumming and fixing, erasing requires a relatively long process time, which, if the erasing were to be performed simultaneously with the other process steps, the overall process time would increase considerably. Consequently, the inventive method is a partially sequential method for producing a permanent as well as erasable image on a printing plate, in which only those process steps that are suitable for being performed simultaneously because of their process parameters are carried out in a chronologically parallel manner.

According to the apparatus of the invention, the imaging device, the gumming device and the fixing device are arranged next to one another, as viewed in the longitudinal direction of the to-be-imaged printing plate and thus in the axial direction of the plate cylinder, and can be moved in the axial direction of the plate cylinder along a traverse so that the imaging and the gumming and the fixing each can be performed relative to one another in a chronologically parallel but spatially sequential manner, wherein the erasing device is arranged beneath or above the imaging device, the gumming device and the fixing device, as viewed in the transverse direction of the to-be-imaged printing plate and thus in the circumferential direction of the plate cylinder, so that the imaging and the gumming and the fixing can be performed relative to the erasing in a chronologically sequential and spatially sequential manner.

Preferred developments of the invention are yielded from the following description. Without being limited hereto, exemplary embodiments of the invention are explained in greater detail in the following making reference to the drawings.

### BRIEF DESCRIPTION OF THE DRAWINGS

FIG. 1 is a very schematic view from above of an inventive device for producing a permanent as well as erasable image on a printing plate.

FIG. 2 is a very schematic view from below of an inventive device for producing a permanent as well as erasable image on a printing plate.

FIG. 3 is a very schematic view from the side of an inventive device for producing a permanent as well as erasable image on a printing plate.

### DETAILED DESCRIPTION OF THE DRAWINGS

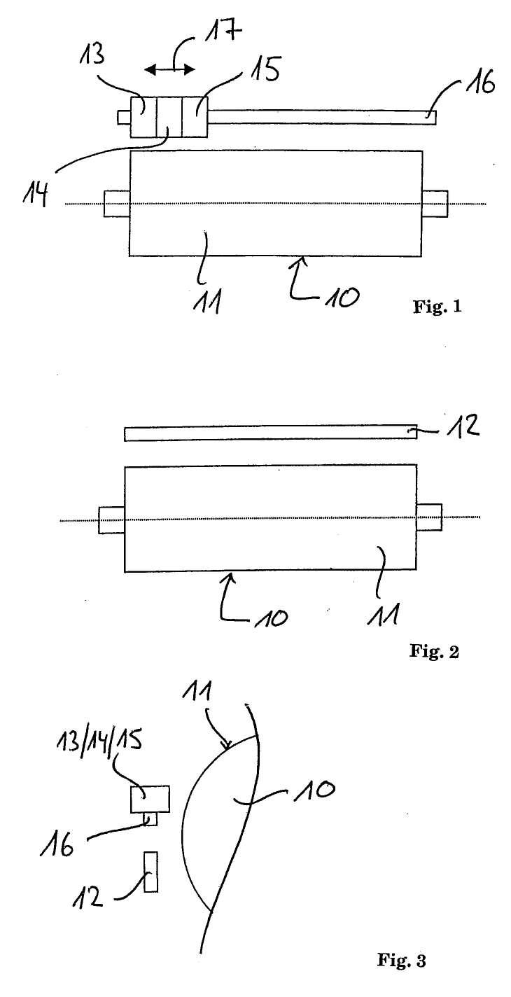

FIGS. 1 through 3 show a plate cylinder 10 of a printing press, on which a to-be-imaged, rewritable as well as erasable printing plate 11 is arranged. Along with the plate cylinder 10 as well as the to-be-imaged printing plate 11, FIGS. 1 through 3 depict an inventive device for producing a permanent as well as erasable image on the printing plate 11, whereby the inventive device features an erasing device 12 for erasing the printing plate 11 arranged on the plate cylinder 10, an imaging device 13, a gumming device 14 as well as a fixing device 15. The imaging device 13 is used for the image-related application of imaging polymer to the to-be-imaged printing plate 11. The gumming device 14 applies a gummed coating to the printing plate 11, in particular to areas of the printing plate that are not supposed to absorb any printing ink and that are still hydrophilic due to the erasing step performed prior to imaging. The fixing device 15 is used for fixing and therefore curing the imaging polymer applied to the printing plate 11 by means of the imaging device 13.

As can be seen particularly well in FIG. 1, the imaging device 13, the gumming device 14 and the fixing device 15 are arranged next to one another, as viewed in the longitudinal direction of the to-be-imaged printing plate 11 and therefore in the axial direction of the plate cylinder 10. The imaging device 13, the gumming device 14 and the fixing device 15 are positioned in a movable manner on a traverse 16 and consequently can be moved along the traverse 16 as shown by the double arrow 17 in the axial direction of the plate cylinder 10 and therefore in the longitudinal direction of the to-be-imaged printing plate 11. The imaging by means of the imaging device 13, the gumming by means of the gumming device 14 and the fixing by means of the fixing device 15 are consequently each performed relative to one another in a chronologically parallel but spatially sequential manner. The imaging, gumming and fixing each take place on the surface areas of the to-be-imaged printing plate 11, in whose environment the imaging device 13, the gumming device 14 and the fixing device 15 are situated due to the movement of the devices along the traverse 16.

The erasing device 12 is positioned beneath the imaging device 13, the gumming device 14 and the fixing device 15, as viewed in the transverse direction of the to-be-imaged printing plate 11 and therefore in the circumferential direction of the plate cylinder 10. The erasing device can also be positioned above the imaging device, the gumming device and the fixing device, as viewed in the circumferential direction of the plate cylinder. The erasing takes place relative to the imaging, gumming and fixing in a chronologically sequential as well as spatially sequential manner. Not until the printing plate 11 has been completely erased does the chronologically simultaneous imaging, gumming and fixing of the plating plate take place.

According to FIG. 2, the erasing device 12 extends over the entire axial extension of the plate cylinder 10. Accordingly, the erasing device 12 has a width that corresponds to the axial extension of the plate cylinder 10 or the longitudinal extension of the printing plate 11. The erasing can consequently take place full-width over the entire axial extension of the plate cylinder and therefore over the entire longitudinal extension of the printing plate 11.

The imaging device 13, the gumming device 14 and the fixing device 15 are preferably positioned on a common carriage and consequently can be moved jointly along the traverse via a common drive. In contrast to this, it also possible, however, for the imaging device, the gumming device and the fixing device to be positioned on individual carriages and thus to be movable individually along the traverse, wherein then each carriage is preferably assigned a separate drive.

The imaging device 13, the gumming device 14 and the fixing device 15 can either be rigidly fixed on the respective carriage or movably positioned on the respective carriage so that the imaging device 13, the gumming device 14 and the fixing device 15 can be engaged with the to-be-imaged printing plate 11 or disengaged from the printing plate perpendicular to the axial direction of the plate cylinder 10.

The present invention consequently makes a device as well as method available for producing a permanent as well as erasable image on a printing plate with a rewritable as well as erasable surface, in which the process steps of imaging, gumming and fixing take place in a chronologically parallel and spatially sequential manner, wherein the process step of erasing, however, takes place relative to imaging, gumming and fixing in both a chronologically as well as spatially sequential manner. The method is performed within the printing press. The erasing device 12, the imaging device 13, the gumming device 14 and the fixing device 15 are consequently integrated into the printing press.

During imaging, gumming, fixing and erasing, the plate cylinder 10 and therefore the printing plate 11 positioned on the plate cylinder 10 are driven in a rotating fashion around the longitudinal axis of the plate cylinder.

In the case of particularly wide plate cylinders 10 having a large axial extension, it is possible to position several units of an imaging device, gumming device and fixing device on the traverse in a movable manner along the plate cylinder. This then makes it possible to reduce the process time even further.

### LIST OF REFERENCE NUMERALS

10 Plate cylinder
11 Printing plate
12 Erasing device
13 Imaging device
14 Gumming device
15 Fixing device
16 Traverse
17 Direction of movement

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for producing a permanent as well as erasable image on a printing plate, wherein, to do so, a printing plate with a rewritable and erasable surface is made available, the surface of the printing plate made available is erased, and a permanent and erasable image is created on the erased surface, wherein following the erasing of the surface, the surface is imaged, gummed and fixed, in such a way that, the imaging and the gumming and the fixing occur relative to the erasing in a chronologically sequential and spatially sequential manner, and that, the imaging and the gumming and the fixing each occur relative to one another in a chronologically parallel but spatially sequential manner.

2. A device for producing a permanent as well as erasable image on a printing plate, having an erasing device for erasing the printing plate arranged on a plate cylinder and having a rewritable and erasable surface, using an imaging device, a gumming device and a fixing device for imaging an erased surface of the printing plate, wherein the imaging device, the gumming device, and the fixing device are arranged next to one another, as viewed in a longitudinal direction of the to-be-imaged printing plate and thus in an axial direction of the plate cylinder, and are moveable in the axial direction of the plate cylinder along a traverse so that imaging and gumming and fixing each is performable relative to one another in a chronologically parallel but spatially sequential manner, and wherein the erasing device is arranged beneath or above the imaging device, the gumming device, and the fixing device, as viewed in a transverse direction of the to-be-imaged printing plate and thus in a circumferential direction of the plate cylinder, so that the imaging and the gumming and the fixing are performable relative to the erasing in a chronologically sequential and spatially sequential manner.

3. The device according to claim 2, wherein the imaging device, the gumming device, and the fixing device are positioned on a common carriage and are moveable jointly along a traverse.

4. The device according to claim 2, wherein the imaging device, the gumming device, and the fixing device are positioned on individual carriages and are moveable individually along a traverse.

5. The device according to claim 3, wherein the imaging device, the gumming device, and the fixing device are rigidly fixed on the common carriage.

6. The device according to claim 3, wherein the imaging device, the gumming device, and the fixing device are movably positioned on the common carriage in such a way that the imaging device, the gumming device, and the fixing device are engageable with the to-be-imaged printing plate or disengageable from the printing plate perpendicular to the axial direction of the plate cylinder.

7. The device according to claim 4, wherein the imaging device, the gumming device, and the fixing device are rigidly fixed on the individual carriages.

8. The device according to claim 4, wherein the imaging device, the gumming device, and the fixing device are movably positioned on the individual carriages in such a way that the imaging device, the gumming device, and the fixing device are engageable with the to-be-imaged printing plate or disengageable from the printing plate perpendicular to the axial direction of the plate cylinder.

9. The device according to claim 2, wherein the erasing device features a width such that the erasing device extends over an entire longitudinal direction of the to-be-erased printing plate.

10. A method for producing an image on a printing plate, comprising the steps of:
erasing a surface of the printing plate and, following the erasing of the surface;
imaging, gumming, and fixing the surface, wherein the imaging and the gumming and the fixing each occur relative to one another in a chronologically parallel but spatially sequential manner, and wherein the imaging and the gumming and the fixing occur relative to the erasing step in a chronologically sequential and a spatially sequential manner.

11. The method according to claim 10, wherein the steps of imaging, gumming, and fixing the surface is performed by an imaging device, a gumming device, and a fixing device, respectively, and wherein the imaging device, the gumming device, and the fixing device are located adjacent to one another and are moved jointly on a traverse.

12. The method according to claim 11, wherein the imaging device, the gumming device, and the fixing device are located adjacent to one another on a carriage and are moved jointly on the carriage on the traverse.

13. The method according to claim 10, wherein the step of erasing the surface of the printing plate is performed by an erasing device.

14. The method according to claim 11, wherein the step of erasing the surface of the printing plate is performed by an erasing device and wherein the erasing device is disposed separate from the traverse.

15. The method according to claim 14, wherein the erasing device is disposed beneath the traverse in a circumferential direction of a printing cylinder that contains the printing plate.

16. An apparatus for producing an image on a printing plate, comprising:
an erasing device for erasing a surface of the printing plate; and
an imaging device, a gumming device, and a fixing device;
wherein the imaging device, the gumming device, and the fixing device perform imaging, gumming, and fixing of the printing plate, respectively, relative to one another in a chronologically parallel but spatially sequential manner, and wherein the imaging, the gumming, and the fixing occur relative to the erasing by the erasing device in a chronologically sequential and a spatially sequential manner.

17. The apparatus according to claim 16, wherein the imaging device, the gumming device, and the fixing device are located adjacent to one another and are moveable jointly on a traverse.

18. The apparatus according to claim 17, wherein the imaging device, the gumming device, and the fixing device are located adjacent to one another on a carriage and are moveable jointly on the carriage on the traverse.

19. The apparatus according to claim 17, wherein the erasing device is disposed separate from the traverse.

20. The apparatus according to claim 19, wherein the erasing device is disposed beneath the traverse in a circumferential direction of a printing cylinder that contains the printing plate.
